(19) United States
(12) Patent Application Publication
(10) Pub. No.: US 2011/0021340 A1
(43) Pub. Date: Jan. 27, 2011

(54) REFRACTORY

(76) Inventors: Karl-Heinz Schofalvi, Cleveland, OH (US); Evelyn McGee DeLiso, Cleveland, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/508,662

(22) Filed: Jul. 24, 2009

(51) Int. Cl. C04B 35/10

(52) U.S. Cl. 501/127

(57) ABSTRACT

The disclosed invention relates to a refractory made from an as-batched composition comprising alumina, a rare earth oxide, and optionally an oxide of a transition metal comprising Sc, Zn, Ga, Y, Cd, In, Sn, Tl or a mixture of two or more thereof, the refractory being characterized by the absence of SiO₂ or a concentration of SiO₂ of no more than about 0.2% by weight.

### TECHNICAL FIELD

This invention relates to refractories and, more particularly, to refractories which may be used in applications, such as liners for furnaces and crucibles, where the refractories come into contact with molten metals such as aluminum, iron or steel, molten glass, and the like.

### BACKGROUND

The process of fabricating aluminum sheet, cans and die cast parts involves holding large bodies of molten aluminum in furnaces and/or crucibles lined with refractories. Refractories, which are materials that can resist melting at high temperatures, may comprise various oxide materials.

### SUMMARY

This invention relates to a refractory made from an as-batched composition comprising alumina, a rare earth oxide, and optionally an oxide of a transition metal comprising Sc, Zn, Ga, Y, Cd, In, Sn, Tl or a mixture of two or more thereof, the refractory being characterized by the absence of SiO₂ or a concentration of SiO₂ that is no more than about 0.2% by weight. The as-batched refractory composition may be characterized by the absence of CaO or a concentration of CaO of no more than about 0.2% by weight.

### BRIEF DESCRIPTION OF THE DRAWINGS

FIG. 1 consists of photographs of test samples from Examples 2 and 3 and Comparative Example 6 after being subjected to a molten aluminum immersion test.

FIGS. 2 and 3 are plots that show the x-ray diffraction pattern for a refractory within the scope of the invention, the refractory having been fired at a temperature above 1600° C.

### DETAILED DESCRIPTION

All ranges and ratio limits disclosed in the specification and claims may be combined in any manner. It is to be understood that unless specifically stated otherwise, references to “a”, “an”, and/or “the” may include one or more than one, and that reference to an item in the singular may also include the item in the plural.

Molten aluminum metal is a strong reducer of oxide materials. A strong chemical driving force exists for molten aluminum to oxidize. This driving force may be thermodynamically characterized by the Gibbs Free Energy of Formation or AG. The more negative the AG, the stronger the driving force. The Gibbs Free Energy of Formation numbers for the reduction of silica and mullite along with their reactions with aluminum are shown below:

Silica: 3SiO₂+4Al→2Al₂O₃+3Si ΔG=−503.1@1700° F.(927° C.)

Mullite: 3(3Al₂O₃.2SiO₂)+8Al→13Al₂O₃+6Si ΔG=−965.3@1700° F.(927° C.)

The problem with using a refractory containing silica in contact with molten aluminum is that silicon from the refractory transfers to the molten aluminum. As silicon is often one of the elemental additions to many aluminum alloys, it is undesirable for the silicon concentration in the aluminum metal to increase as a result of contact with the aluminum contact refractory. This invention provides a solution to this problem. With the present invention, a refractory is employed that is made from an as-batched composition comprising alumina, a rare earth oxide, and a transition metal oxide. The refractory may be characterized by the absence of SiO₂ or a concentration of SiO₂ that is no more than about 0.2% by weight. The refractory may be a non-reactive or substantially non-reactive refractory for molten aluminum.

Another problem resulting from the reduction of SiO₂ by molten aluminum is that alumina or corundum is often formed. At the air-metal-refractory interface the formation of corundum often creates bulbous-shaped black growths which attach themselves to the refractory surface. As the reduction of SiO₂ and formation of alumina occurs at the interface of the molten metal and the refractory, the front of the reaction pathway often penetrates into the refractory wall via capillary infiltration. These reaction fronts proceed into the refractory wall and cause the bulbous shaped black growths to adhere in the refractory wall. As part of standard reverbatory or crucible furnace operation, the metal surface is skimmed with a tool, and a boom tool is used to scrape the sidewalls of the furnace to remove the corundum growth. During the scraping process, it is quite common to pull the corundum away from the wall and also to pull out chunks of refractory. This operation reduces the thickness of the refractory wall, and this in turn decreases the lifetime of the refractory wall. This is also an energy consuming process as the heat put into the furnace has to be increased in order to maintain the molten metal temperature at around 1200-1500° F. (649-816° C.). The problem therefore is to prevent or reduce the growth of corundum. By use of the inventive refractory it is possible to prevent or reduce the formation of the corundum growth and thereby increase the ease of furnace sidewall scraping maintenance. This invention provides a solution to this problem by providing an aluminum contact refractory characterized by the absence or substantial absence of SiO₂ (i.e., a concentration of SiO₂ of no more than about 0.2% by weight).

The inventive refractory may be made from an as-batched composition comprising alumina and one or more rare earth oxides. The as-batched composition for making the inventive refractory may optionally further comprise one or more oxides of a transitional metal, the transition metal being Sc, Zn, Ga, Y, Cd, In, Sn, Tl or a mixture of two or more thereof. The as-batched composition may be fired to make the inventive refractory. The term “as-batched” refers to the composition used to make the inventive refractory prior to firing. The as-batched composition as well as the inventive refractory may be characterized by the absence of SiO₂, or the substantial absence of SiO₂, that is, a concentration of SiO₂ of no more than about 0.2% by weight, and in one embodiment no more than about 0.15% by weight, and in one embodiment no more than about 0.1% by weight, and in one embodiment no more than about 0.08% by weight. The concentration of SiO₂ may be no more than a trace amount.

The as-batched composition as well as the inventive refractory may be characterized by the absence of CaO, or the substantial absence of CaO, that is, a concentration of CaO of no more than about 0.2% by weight, and in one embodiment no more than about 0.15% by weight, and in one embodiment no more than about 0.1% by weight, and in one embodiment no more than about 0.08% by weight, and in one embodiment no more than about 0.05% by weight, and in one embodiment no more than about 0.02% by weight, and in one embodiment no more than about 0.015% by weight, and in one embodiment no more than about 0.012% by weight. The concentration of CaO may be no more than a trace amount.

The alumina used to make the inventive refractory may be in the form of alumina particulates. The alumina may comprise a hydratable alumina such as dehydrated boehmite. The alumina may comprise alpha-alumina. The as-batched composition may be made with alumina particulates. The alumina particulates may have a mean particle size in the range from about 0.4 to about 5000 microns, and in one embodiment in the range from about 0.5 to about 3000 microns. The concentration of alumina particulates in the as-batched composition for making the inventive refractory may be in the range from about 45 to about 98% by weight, and in one embodiment in the range from about 60% to about 98% by weight, and in one embodiment in the range from about 75% to about 98% by weight, and in one embodiment in the range from about 85 to about 98% by weight, and in one embodiment in the range from about 91 to about 98% by weight.

The rare earth oxide may be an oxide of Pr, La, Ce, Nd, Pm, Sm, Eu, Gd, Tb, Dy, Ho, Er, Tm, Yb, Lu, or a mixture of two or more thereof. Pr may be particularly useful. The rare earth oxide in the as-batched composition for making the inventive refractory may comprise Pr₆O₁₁. The rare earth oxide may be employed at an effective concentration to function as refractory enhancer. The rare earth oxide employed in the as-batched refractory composition may be in the form of particulate solids. The rare earth oxide particulates may have a mean particle size in the range from about 0.1 to about 10 microns, and in one embodiment in the range from about 1 to about 7.5 microns. The concentration of the rare earth oxide in the as-batched refractory composition may be in the range from about 1 to about 55% by weight, and in one embodiment in the range from about 1 to about 40% by weight, and in one embodiment in the range from about 1 to about 25% by weight, and in one embodiment in the range from about 1 to about 15% by weight, and in one embodiment in the range from about 1 to about 10% by weight, and in one embodiment in the range from about 2 to about 8% by weight.

As indicated above, an optional component may be a transition metal which may comprise Sc, Zn, Ga, Y, Cd, In, Sn, Tl, or a mixture of two or more thereof. Y may be particularly useful, The transition metal oxide that may be used in the as-batched composition for making the inventive refractory may comprise Y₂O₃. The transition metal oxide may function as a binding agent for the refractory. The transition metal oxide employed in the as-batched refractory composition may be in the form of particulate solids. The transition metal oxide particulates may have a mean particle size in the range from about 0.1 to about 10 microns, and in one embodiment in the range from about 1 to about 2.5 microns. The concentration of the transition metal in the inventive refractory may be an effective amount to function as a binding agent for the refractory. The concentration of the transition metal in the as-batched refractory composition may be in the range up to about 5% by weight, and in one embodiment in the range up to about 2% by weight, and in one embodiment in the range from about 0.01 to about 5% by weight, and in one embodiment in the range from about 0.01 to about 2% by weight, and in one embodiment in the range from about 0.05 to about 2% by weight, and in one embodiment in the range from about 0.1 to about 1.5% by weight, and in one embodiment from about 0.1 to about 1.2% by weight.

Non-wetting molten metal additives may be incorporated into the refractory composition. These may include barium sulfate, aluminum fluoride, boron nitride, or a mixture of two or more thereof. However, while these additives may render the refractory non-wetting to molten aluminum initially, their effectiveness may wear off with time. For example, due to the high temperature firing procedure used for making the inventive refractory, barium sulfate may be burned out of the refractory during the firing process. On the other hand, a unique feature of the inventive refractory is that the non-wetting behavior with molten aluminum may occur without the addition of a non-wetting additive. Thus, in one embodiment, the inventive refractory may be characterized by the absence of any non-wetting molten metal additives. Also, the as-batched refractory composition for making the inventive refractory may be characterized by the absence of any non-wetting molten metal additives.

The use of the alumina aggregate is optional but when used the alumina aggregate may aid in shrink control as well as provide enhanced physical and performance properties. The alumina aggregate may have a particle size in the −28 and +325 mesh size range. The expression “−28 and +325 mesh size” is used herein to refer to particulates that are of a sufficient size to flow through a screen with a 28 mesh size but be retained on a screen with a 325 mesh size. Particle size ranges within the foregoing range, such as between −28 and +65 or between −65 and +325, may be used. Combinations of the foregoing size ranges may be used. The alumina aggregate may comprise alpha-alumina, gamma-alumina, eta-alumina, rho-alumina, delta-alumina, theta-alumina, or a mixture of two or more thereof. Upon firing the alumina that is not alpha-alumina may convert to alpha-alumina. The concentration of alumina aggregate in the as-batched composition used to form the inventive refractory may be up to about 50% by weight, and in one embodiment in the range from about 1 to about 50% by weight, and in one embodiment in the range from about 10 to about 50% by weight, and in one embodiment in the range from about 20 to about 50% by weight.

The inventive refractory may be made by initially forming the as-batched composition, which may be in the form of particulate solids, using standard mixing techniques. The as-batched composition may be molded, dried and fired. The firing procedure may involve heating the as-batched composition to a temperature in the range from about 1600 to about 1800° C. over a period of time in the range from about 15 hours to about 25 hours, and in one embodiment from about 17 to about 22 hours; holding the temperature in that range for a period of time in the range from about 0.5 to about 4 hours, and in one embodiment from about 1 to about 2 hours; and then reducing the temperature to about 30° over a period of time in the range from about 5 to about 18 hours, and in one embodiment from about 8 to about 12 hours. The firing procedure may follow one of the following firing schedules procedures A-D.

Firing schedule A: This firing schedule may be used with large shapes and a top temperature hold of about 1700° C. for about two hours. The molded and dried as-batched refractory composition may be fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1700° C. at a rate of about 20° C./hr.; (5) holding the temperature constant at about 1700° C. for about two hours; and (6) reducing the temperature from about 1700° C. to about 30° C. at a rate of about 100° C./hr.

Firing schedule B: This firing schedule may employ a top temperature hold of about 1700° C. for about one hour. The molded and dried as-batched refractory composition may be fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1700° C. at a rate of about 20° C./hr.; (5) holding the temperature constant at about 1700° C. for about one hour; and (6) reducing the temperature from about 1700° C. to about 30° C. at a rate of about 178° C./hr.

Firing schedule C: This procedure may employ a top temperature hold of about 1600° C. for about one hour. The molded and dried as-batched refractory composition may be fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1600° C. at a rate of about 35° C./hr.; (4) holding the temperature constant at about 1600° C. for about one hour; and (5) reducing the temperature from about 1600° C. to about 30° C. at a rate of about 178° C./hr.

Firing Schedule D: This firing schedule may employ a top temperature hold of about 1750° C. for about one hour. The molded and dried as-batched refractory composition may be fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1750° C. at a rate of about 20° C./hr.; (5) holding the temperature constant at about 1750° C. for about one hour; (6) reducing the temperature from about 1750° C. to about 1650° C. at a rate of about 35° C./hr.; and (7) reducing the temperature from about 1650° C. to about 30° C. at a rate of about 178° C./hr.

The inventive refractory may be formed to provide any desired shape depending upon its intended use. The inventive refractory may be used in high temperature applications wherein thermal cycling may be expected and high impact resistance may be required. These may include furnace wall linings for use in processing molten metals such as aluminum, iron and steel, as well as molten glass. These may include slide gates, tundish lances, and various castable shapes such as cones and mill rolls for use in the iron, steel, aluminum and glass industries. The inventive refractory may be used in fuel cells, such as for use in making insulator plates, reformer box housings, and the like. The inventive refractory may be useful in making electric kiln tiles, and the like. The inventive refractory may be used in making catalyst supports for hot (for example, temperatures up to about 1600° C.) gaseous process (for example, removal of particulates, sulfur, NOx, and the like, from exhaust gas streams), filter mediums for hot (for example, temperatures up to about 1200° C.) gaseous separations, and the like. The inventive refractory may be used in making various castable shapes for use in the aluminum industry.

While not wishing to be bound by theory, it is believed that, at least when the rare earth oxide is an oxide of praseodymium, the enhanced performance results achieved with the inventive refractory may be a consequence of unique bonding as well as unique praseodymium aluminate phases that form in these refractories. The formation of these unique phases may be a consequence of high purity raw materials that may be used in making these refractories as well as the above-noted high temperature firing process that may be used. The high purity raw materials may include the use of a hydratable alumina bond characterized by the absence or substantial absence of SiO₂. These materials may also be characterized by the absence or substantial absence of CaO. The term “substantial absence” of SiO₂ or CaO refers to a SiO₂ or CaO content of no more than about 0.2% by weight, and in one embodiment no more than about 0.1% by weight. The unique bonding phase, which may be characterized by the absence or substantial absence of SiO₂ and CaO, may be formed using a hydratable alumina bond. With the use of a hydratable alumina bond, there may be no additional oxide impurity that is incorporated into the inventive refractory. The unique praseodymium aluminate phase may be green in color. A pale green color indicates that the praseodymium ions may be trivalent. The praseodymium raw material, Pr₆O₁₁, may have a dark gray-brown color. When the inventive refractories are fired at a temperature greater than about 1600° C. in air, the praseodymium ion incorporated in the oxide phases is present as Pr³⁺ which is green in color.

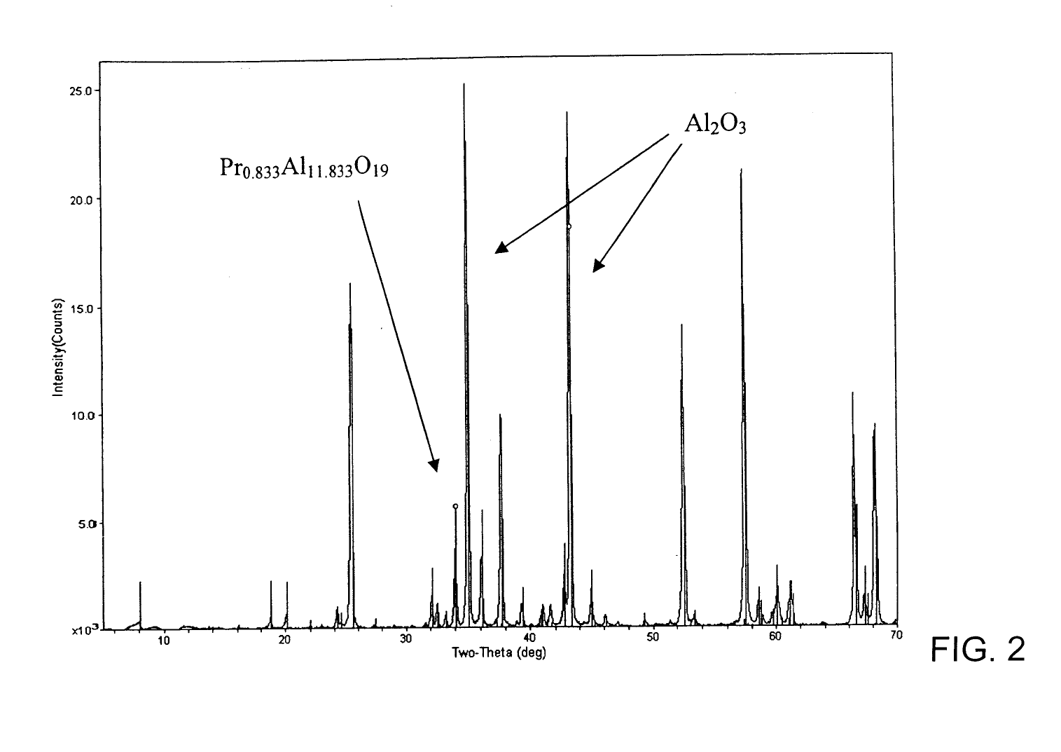

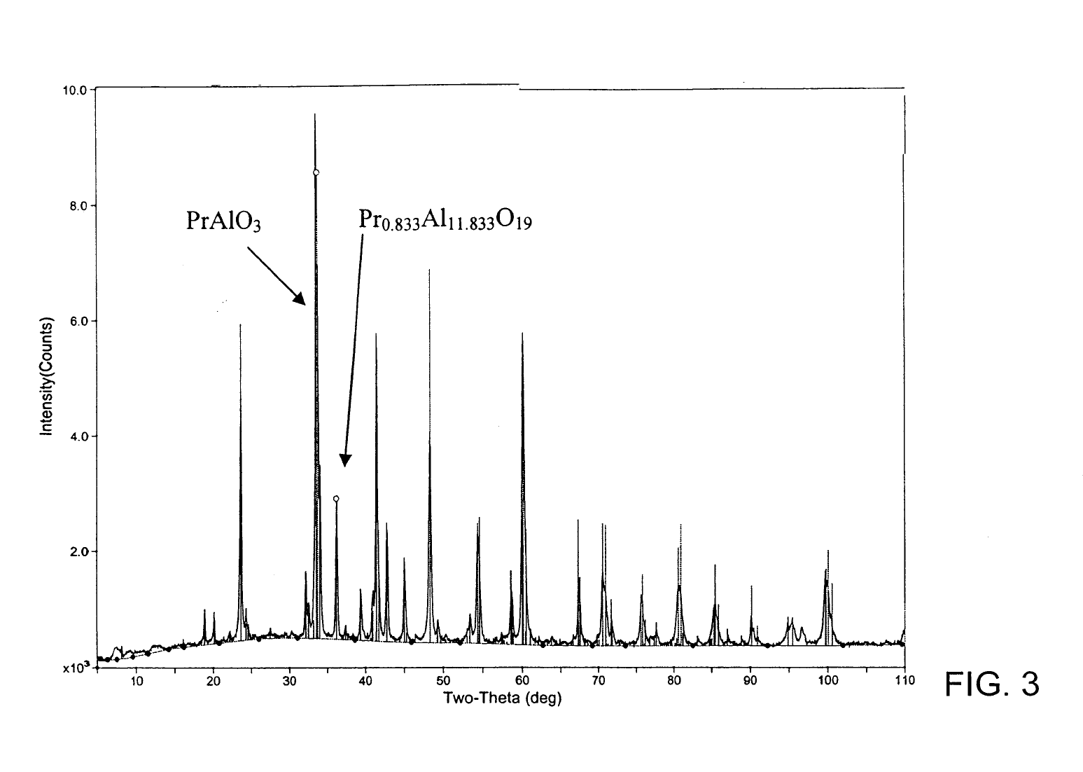

The phases present in the inventive refractory, when fired at a temperature above about 1600° C., may comprise Al₂O₃ and Pr_{0.833}Al_{11.833}O₁₉ as shown in FIG. 2, and Pr_{0.833} Al_{11.833}O₁₉ and PrAlO₃, as shown in FIG. 3. In FIG. 2, the main peak for Pr_{0.833}Al_{11.833}O₁₉ at 2⊖=34.042 and 100% intensity. The main peak for Al₂O₃ at 2⊖=35.157 and 100% intensity. The secondary peak for Al₂O₃ at 2⊖=43.368 and 86.7% intensity. In FIG. 3, the main peak for PrAl₂O₃ at 2⊖=33.752 and 100% intensity. The secondary peak for Pr_{0.833}Al_{11.833}O₁₉ at 2⊖=36.185 and 95.4% intensity. The praseodymium aluminate phase may comprise a defect magnetoplumbite-like structure.

### Example 1

A refractory composition is made by mixing particulate solids of Alphabond 300, praseodymia and yttria to obtain an as-batched composition containing 96.7 wt % Al₂O₃, 3.1 wt % Pr₆O₁₁ and 0.15 wt % Y₂O₃. Alphabond 300 is a product of Almatis identified as a hydratable alumina bond containing 91.5-95% by weight dehydrated boehmite. The batch is mixed and test bars are molded and dried. The test bars are fired in a furnace at a temperature above 1600° C. with a hold at the top temperature for 10 to 300 minutes.

A test brick made according to Example 1 is tested in the Alcoa Cup Test with a 7075 aluminum alloy at 1500° F. (816° C.) for 72 hours. An analysis of the 7075 aluminum alloy is taken before and after the test to determine the levels of pick-up for silicon and iron. These metal pick-ups may occur because of breakdowns in the refractory material in contact with the molten 7075 aluminum alloy. The pick-up of silicon is 0.001% by weight and the pick-up of iron is 0.01% by weight.

### Examples 2 to 5

Following the batching procedure used for Example 1, the levels of Al₂O₃, Pr₆O₁₁, and Y₂O₃ are varied as shown in Table I (all percentages are by weight).

TABLE I

| | Example | Example | Example | Example | Comparative |
|---|---|---|---|---|---|
| | 2 | 3 | 4 | 5 | Example 6 |
| | (%) | (%) | (%) | (%) | (%) |
| Al₂O₃ | 97.7 | 92.1 | 92.1 | 93.0 | 90.2 |
| Pr₆O₁₁ | 2.0 | 7.6 | 6.7 | 6.8 | none |
| Y₂O₃ | 0.1 | 0.1 | 1.0 | 0.0 | none |
| SiO₂ | 0.1 | 0.1 | 0.1 | 0.1 | 9.6 |
| MgO | none | none | none | none | 0.1 |
| Na₂O + | 0.1 | 0.1 | 0.1 | 0.1 | 0.1 |
| K₂O | | | | | |

Comparative Example 6 is a commercially available high alumina refractory. The composition of Comparative Example 6 is also shown in Table I.

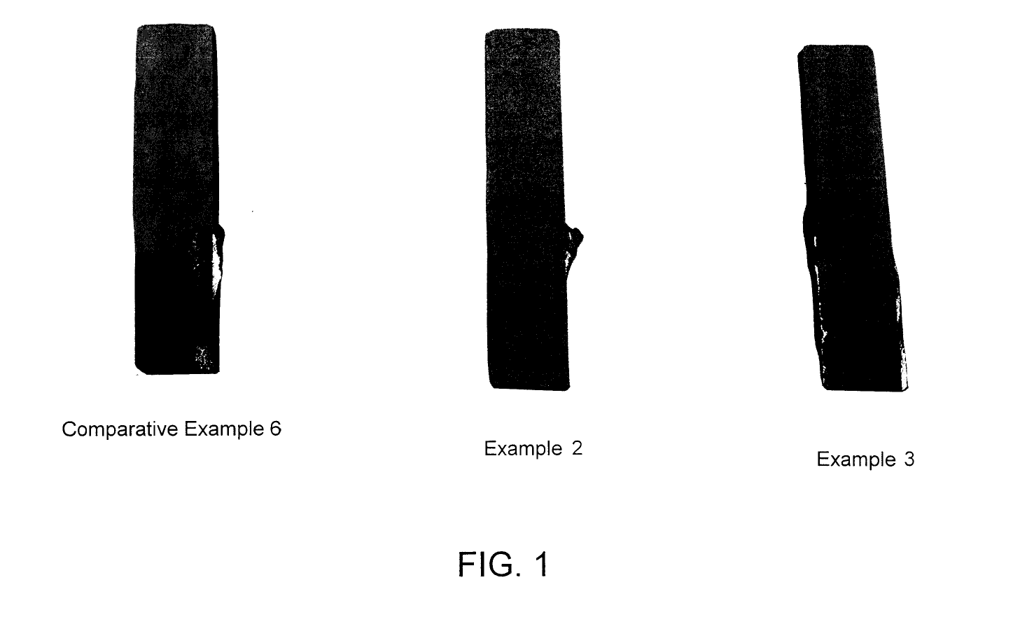

Refractory samples measuring approximately 1×1×6 inches in size of Examples 2 and 3 and Comparative Example 6 are tested in a molten aluminum immersion test. The samples are immersed in a bath of molten aluminum so that there is refractory below the molten aluminum metal line and above the molten aluminum metal line. The test parameters are rotational immersion in a bath of a seven thousand series alloy for 7 days at 1300° F. (704° C.). The samples are rotated at 86 rpm. Every twenty-four hours, the samples are removed from the molten aluminum metal bath for observation. The molten metal bath is skimmed for removal of oxide build-up on the metal surface and additional metal is added to the bath to maintain a consistent level of molten metal on the refractory surface. At the end of the seven day test, the samples are removed from the bath. The samples are cooled. The samples are cut longitudinally for visual inspection. Cross sections of the longitudinal samples for Comparative Example 6, Example 2 and Example 3 are shown in FIG. 1. As can be seen from the photographs, the Comparative Example 6 sample is penetrated with metal below the molten metal line and slightly above the molten metal line. The inventive compositions, Example 2 and Example 3, are not penetrated by metal.

Using the procedure described in Example 1, a block of the refractory from Example 2 is made. The as-batched dry powder composition size is 12,800 gm. The as-batched composition is molded in a 10 inch×10 inch mold with a thickness of about 3 inches before firing. After firing using Firing Schedule A, four samples (Examples 2a-2d) are cut from the resulting refractory block and tested for abrasion resistance using the test method ASTM C-704. The samples are abraded by being exposed to a blast of SiC grit. The volume of material removed from each sample in cubic centimeters (cc) is as follows:

| | |
|---|---|
| Example 2a | 7.74 cc |
| Example 2b | 8.40 cc |
| Example 2c | 10.07 cc |
| Example 2c | 14.19 cc |
| Average | 10.10 cc |

The results indicate that the refractory of Example 2 is a hard durable refractory material with excellent abrasion resistance characteristics.

A compositional study is undertaken for binary mixtures of Pr₆O₁₁ and Al₂O₃. The amount of Pr₆O₁₁ is varied as shown in Table II. 400 gm samples are mixed in a mortar and pestle. A liquid component is added to the mixed powders and samples are cast into round molds. The samples are dried and then fired to 1500° C., 1600° C., 1700° C. or 1750° C. The density of each sample after firing is determined. The results are shown in Table II. In Table II, the numerical values are in grams per cubic centimeter.

TABLE II

| | 1500° C. | 1600° C. | 1700° C. | 1750° C. |
|---|---|---|---|---|
| 100% Al₂O₃ | 2.52 | 2.79 | 3.06 | 3.27 |
| 5% Pr₆O₁₁, 95% Al₂O₃ | 2.26 | 2.54 | 3.04 | 3.45 |
| 10% Pr₆O₁₁, 90% Al₂O₃ | 2.35 | 2.29 | 2.99 | 3.51 |
| 15% Pr₆O₁₁, 85% Al₂O₃ | 1.89 | 1.94 | 2.14 | 2.79 |
| 20% Pr₆O₁₁, 80% Al₂O₃ | 2.42 | 2.37 | 2.42 | 3.06 |
| 50% Pr₆O₁₁, 50% Al₂O₃ | 2.64 | 2.97 | 3.58 | 4.54 |

This study shows that a firing temperature of at least 1600° C. is needed in order for the reaction of Pr₆O₁₁ and Al₂O₃ to occur. The level of completeness is determined by the color change that occurs during firing. The initially gray-colored unfired ceramic sample turns to a green color during firing. The higher the level of Pr₆O₁₁ in the sample, the greener the color. At 1500° C. the samples are a mixture of gray and green color and the reaction is not complete. The sample containing 50% Pr₆O₁₁ and fired to 1750° C. is a high density material with the darkest green color.

While the invention has been explained in relation to various embodiments, it is to be understood that modifications thereof may become apparent to those skilled in the art upon reading the specification. Therefore, it is to be understood that the scope of the invention described herein is intended to include all modifications that are within the scope of the appended claims.

1. A refractory made from an as-batched composition comprising alumina and a rare earth oxide, the refractory being characterized by the absence of SiO₂ or a concentration of SiO₂ of no more than about 0.2% by weight.

2. The refractory of claim 1 wherein the as-batched composition further comprises an oxide of a transition metal comprising Sc, Zn, Ga, Y, Cd, In, Sn, Tl or a mixture of two or more thereof.

3. The refractory of claim 1 wherein the alumina comprises a hydratable alumina.

4. The refractory of claim 1 wherein the alumina comprises dehydrated boehmite.

5. The refractory of claim 1 wherein the alumina comprises alpha-alumina.

6. The refractory of claim 1 wherein the concentration of alumina is in the range from about 45% to about 98% by weight.

7. The refractory of claim 1 wherein the rare earth oxide comprises an oxide of Pr, La, Ce, Nd, Pm, Sm, Eu, Gd, Tb, Dy, Ho, Er, Tm, Yb, Lu, or a mixture of two or more thereof.

8. The refractory of claim 2 wherein the rare earth oxide comprises Pr₆O₁₁, and the transition metal oxide comprises Y₂O₃.

9. The refractory of claim 2 wherein the concentration of the rare earth oxide is in the range from about 1 to about 55% by weight, and the concentration of the transition metal oxide is in the range up to about 5% by weight.

10. The refractory of claim 1 wherein the as-batched composition further comprises alumina aggregate.

11. The refractory of claim 1 wherein the as-batched composition is fired by heating the composition to a temperature in the range from about 1600° to about 1800° C. over a period of time in the range from about 15 to about 25 hours, holding the temperature in that range for a period of time in the range from about 0.5 to about 4 hours, and reducing the temperature to about 30° C. over a period of time in the range from about 5 to about 18 hours.

12. The refractory of claim 1 wherein the as-batch composition is fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1700° C. at a rate of about 20° C./hr.; (5) holding the temperature constant at about 1700° C. for about two hours; and (6) reducing the temperature from about 1700° C. to about 30° C. at a rate of about 100° C./hr.

13. The refractory of claim 1 wherein the as-batched composition is fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1700° C. at a rate of about 20° C./hr.; (5) holding the temperature constant at about 1700° C. for about one hour; and (6) reducing the temperature from about 1700° C. to about 30° C. at a rate of about 178° C./hr.

14. The refractory of claim 1 wherein the as-batched composition is fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1600° C. at a rate of about 35° C./hr.; (4) holding the temperature constant at about 1600° C. for about one hour; and (5) reducing the temperature from about 1600° C. to about 30° C. at a rate of about 178° C./hr.

15. The refractory of claim 1 wherein the as-batched composition is fired using the following procedure: (1) heating the as-batched composition from a temperature of about 30° C. to about 1450° C. at a rate of about 100° C./hr; (2) increasing the temperature from about 1450° C. to about 1550° C. at a rate of about 60° C./hr; (3) increasing the temperature from about 1550° C. to about 1650° C. at a rate of about 35° C./hr.; (4) increasing the temperature from about 1650° C. to about 1750° C. at a rate of about 20° C./hr.; (5) holding the temperature constant at about 1750° C. for about one hour; (6) reducing the temperature from about 1750° C. to about 1650° C. at a rate of about 35° C./hr.; and (7) reducing the temperature from about 1650° C. to about 30° C. at a rate of about 178° C./hr.
